(19) United States
(12) Patent Application Publication
(10) Pub. No.: US 2003/0174775 A1
(43) Pub. Date: Sep. 18, 2003

(54) Encoding and decoding apparatus, method for monitoring images

(75) Inventors: Shigeki Nagaya, Tokyo (JP); Yoshinori Suzuki, Saitama (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/317,086

(22) Filed: Dec. 12, 2002

(30) Foreign Application Priority Data
Mar. 13, 2002 (JP) 2002-068602

(51) Int. Cl. H04N 7/12

(52) U.S. Cl. 375/240.12; 348/159; 375/240.16

(57) ABSTRACT

In coding by use of DCT transform and motion compensation, frame memories for each storing an input image for each of different shooting places are provided, and at the start of pan-tilt-zoom motion of camera, an input image to be coded is switched from an input image from the camera to a past input image in a shooting place after the end of the pan-tilt-zoom motion, stored in the frame memories. Or in addition to frame memories for storing decoded images by local decoding, a reference image memory for storing a decoded image for each of shooting places of surveillance target as a reference image, read from the frame memories, is provided so that, during camera switching, a decoded image used to detect motion vectors is switched from a decoded image of an input image to a past reference image in a shooting place after camera switching, stored in the reference image memory.

### BACKGROUND OF THE INVENTION

The present invention relates to a coding or decoding technique for compressing moving image data, and more particularly to a coding or decoding technique combined with DCT (discrete cosine transform) and motion compensation.

The MPEG (Motion Picture Experts Group) specification, international standards of coding and decoding for compressing moving image data, is a highly efficient coding system combined with motion compensation inter-frame prediction and DCT (discrete cosine transform) coding. The MPEG specification has contributed to significant reduction in transmission bands, and has enabled high quality digital broadcasting and the production of DVD (Digital Versatile Disk) capable of recording long programs more than one hour.

Recently, in addition to MPEG-1 and MPEG-2 employed in the digital broadcasting and DVD, MPEG-4 has been internationally standardized which has a wider range of use and is capable of multimedia including moving images and music.

Using MPEG-4 as an example, a description will be made of basic coding and decoding processing for moving images. As shown in FIG. 13, one frame of a moving image consists of one luminance signal (Y signal: 2001) and two color difference signals (Cr signal: 2002, Cb signal: 2003), and image size as data amount of the color difference signal is half that of the luminance signal both in length and width.

In coding by the MPEG-4 video (moving image) specification, each frame of a moving image is split into small blocks as shown in FIG. 13, and reconstruction processing is performed in units of blocks called macroblocks (MB).

FIG. 14 shows the structure of macroblock. A macroblock consists of one Y signal block 2101 of 16 by 16 pixels, and a Cr signal block 2102 and a Cb signal block 2103 of 8 by 8 pixels each that coincide spatially with the Y signal. The Y signal block may be further split into four blocks (2101-1, 2101-2, 2101-3, and 2101-4) of 8 by 8 pixel blocks each.

MPEG-4 video is processed in units of macroblcoks described above. Coding methods are broadly classified as intra-frame coding (INTRA) and predictive coding that is inter-frame coding (INTER).

FIG. 15 shows a configuration of an encoding apparatus for MPEG-4 video. The intra-frame coding method is a data compression method in a spatial direction namely within frame, which performs directly DCT for an image of six blocks of 8 by 8 pixels each to be coded, and quantizes and codes transformation coefficients. Intra-frame coding for one block of 8 by 8 pixels is described using FIG. 15.

An input image 200 is split into MBs (macroblocks) in an MB splitting part 300. An input block image 201 produced as a result of the splitting is transformed into 64 DCT coefficients in a DCT transformer 203. The DCT coefficients are quantized in a quantizer 204 according to quantization parameters (values determining quantization accuracy: movement range from 1 to 31 in MPEG-4, determined from a coded bit count 310 of preceding MB obtained from multiplexer 206, target bit rate, and the like), and are passed to the multiplexer 206 and coded therein. At this time, quantization parameters are also passed to the multiplexer 206 and coded therein.

The quantized DCT coefficients are decoded to an input block image in a dequantizer 207 and inverse DCT transformer 208 of local decoder 220, and stored in a frame memory 210. The local decoder 220 is configured to have the capability to create the same as a decoded image in a decoding side.

The image stored in the frame memory is used for prediction in time direction namely between frames. The intra-frame coding is performed for macroblocks (including the first frame to be coded) having no similarity in a preceding frame, and portions from which storage operation errors resulting from DCT are to be eliminated.

On the other hand, a predictive coding algorithm is referred to as MC-DCT (motion compensation—discrete cosine transform). Predictive coding for one macroblock is described using FIG. 15.

An input image 200 is split into MBs in the MB splitting part 300. Motion compensation between an input macroblock image 201 produced as a result of the splitting and a decoded image of a preceding frame, stored in the frame memory 201, is performed in a motion compensation unit 211. The motion compensation is a compression technique of time direction by which a portion similar to the contents of a target macroblock (generally, a portion small in the sum of the absolute values of predictive error signals within a luminance signal block in a search area of the preceding frame is selected) is searched in a preceding frame, and an amount of the motion (local motion vectors) is coded. A decoded image of the preceding frame, stored in the frame memory 210, is used as a reference image for motion compensation.

FIG. 16 shows a processing structure of motion compensation. In FIG. 16, for a luminance signal block 52 of a current frame 51, enclosed by a bold frame, a predictive block 55 and a local motion vector 56 on a preceding frame 53 are shown in a search area 57.

The local motion vector 56 is a vector indicating a movement portion from a block 54 (dashed line) of the preceding frame corresponding to a spatially same position for the bold block of the current frame to a predictive block 55 on the preceding frame. Motion vector length for the color difference signal is half that of the luminance signal and is not coded. A detected local vector 212 shown in FIG. 15 is coded in a multiplexing unit 206.

Subtraction between a predictive macroblock image 213 extracted from the preceding frame by motion compensation and the input macroblock image 201 of the current frame is performed by a subtraction unit 202, and a prediction error macroblock image is created.

The prediction error macroblock image is inputted to a DCT unit 203 for each of six 8-by-8 pixel blocks (2101-1, 2101-2, 2101-3, 2101-4, 2002, 2003) shown in FIG. 14 and is transformed to 64 DCT coefficients. Each DCT coefficient is quantized in the quantizer 204 according to quantization parameters, and passed to the multiplexer 206 along with the quantization parameters, and coded.

Also in the case of predictive coding, quantization DCT coefficients are decoded to a prediction error macroblock image in the dequantizer 207 and inverse DCT transformer 208 of the local decoder 220, and the prediction error macroblock image is added to a predictive macroblock image in an adder 209 before being stored in frame memory 210.

Whether to apply intra-frame coding (INTRA) or inter-frame coding (INTER) is judged in units of MBs in intra/inter switcher 214. Generally, for the judgment, the following values are used as evaluation values: for INTER, the sum of the absolute values of predictive errors in a luminance signal block, and for INTRA, the sum of the absolute values of errors of average values within a luminance signal block.

In the MPEG-4 specification, a frame to all macroblocks of which intra-frame coding is subjected is referred to as I-VOP (Intra-coded Video Object Plane), and a frame to all macroblocks of which predictive coding and intra-frame coding blocking are subjected is referred to as P-VOP (Predictive-coded VOP). In rectangular images, VOP is synonymous with frame. Since I-VOP does not require decoded information of past frames, it is used as a decoding start frame during random access or as a frame for refreshing deterioration in image quality caused by DCT operation errors.

For P-VOP, it is judged by the intra/inter switcher 214 of FIG. 15 whether to apply predictive coding or intra-frame coding to macroblocks, and prediction mode 218 as judgment result is coded in the multiplexing unit 206. Variable length coding is adopted for the coding.

In addition to the predictive coding and the intra-frame coding, bi-directionally predictive coding is available which performs motion compensation (hereinafter referred to as MC) using past and future frame information. Frames using this coding method are referred to as B-VOP (Bidirectionally predicted-coded VOP).

In this way, coded data 230 subjected to compression processing is outputted from the multiplexing unit 206.

On the other hand, reconstruction processing in the decoding side is performed according to the reverse procedure of the coding. FIG. 17 shows a configuration of a decoding apparatus. A decoding unit 501 analyzes inputted coded data 230 and transforms binary codes into meaningful decoded information. Motion information and predictive mode information are distributed to a motion compensation unit 504, and quantization DCT coefficient information to a dequantizer 502.

If predictive mode of an analyzed macroblock is intra-frame coding, decoded quantization DCT coefficient information is subjected to dequantization and inverse DCT processing for each of 8-by-8 pixel blocks in the dequantizer 502 and the inverse DCT unit 503 to reconstruct macroblock images. The reconstructed macroblock images are synthesized in units of macroblocks in a compositor 506, and a decoded frame image 520 is outputted. The decoded frame image 520 is stored in a frame memory 507 to predict a next frame.

If predictive mode of the macroblock is predictive coding, decoded local motion vector information is inputted to the motion compensation unit 504. The motion compensation unit 504 extracts a predictive macroblock image from the frame memory 507 in which a decoded image of a preceding frame is stored, according to a motion amount.

Next, coded data on a predictive error signal is subjected to dequantization and inverse DCT processing for each of 8-by-8 pixel blocks in the dequantizer 502 and the inverse DCT unit 503 to reconstruct macroblock images, and a prediction error macroblcok image is reconstructed.

The predictive macroblock image and the prediction error macroblcok image are subjected to addition processing in an adder 505 to reconstruct a macroblock image. The reconstructed macroblock images are synthesized in units of macroblocks in the compositor 506, and a decoded frame image 520 is outputted. The decoded frame image 520 is stored in a frame memory 507 to predict a next frame. Thus, a prediction unit is configured by a closed loop consisting of the motion compensation unit 504, adder 505, frame memory 507, and compositor 506.

FIGS. 18, 19, and 20 show a basic data structure of coded data 230 complying with the MPEG-4 specification. Numeral 1800 in FIG. 18 denotes an overall data structure, 1900 in FIG. 19 denotes a data structure of frame header, and 2200 in FIG. 20 denotes a data structure of macroblock.

A VOS header, in FIG. 18, includes profile level information determining an application range of products complying with the MPEG-4 specification; a VO header includes version information determining a data structure of MPEG-4 video coding; and a VOL header includes image size, coding bit rate, frame memory size, available tool, and other information. Any of these information items is information required to decode coded data. A GOV header include time information, which is not indispensable and may be omitted.

Since any of the VOS header, VO header, VOL header, and GOV header begins in a unique word, they can be easily retrieved. End code of VOS indicating the end of sequence is also a 32-bit unique word. These unique words begin with 23 “0”s and one “1” consisting of 24 bits, followed by 2-byte data, which indicates the type of the boundary.

VOP contains data of each frame (referred to as VOP in MPEG-4 video) of moving images. VOP begins with a VOP header 1900 shown in FIG. 19, followed by macroblock data 2200 shown in FIG. 20, which extends from left to right and from top to bottom of the frame.

FIG. 19 shows a data structure of the VOP header 1900. It begins with a 32-bit unique word called a VOP start code vop_coding_type designates a coding type (I-VOP, P-VOP, B-VOP, S-VOP) of VOP (S-VOP is described later), followed by modulo_time_base and vop_time_increment, which are time stamps indicating the output time of the VOP.

modulo_time_base is information in seconds and vop_time_increment is information of less than second. Information about accuracy of vop_time_increment is indicated by vop_time_increment_resolution information contained in the VOL header.

The modulo_time_base information is a value indicating changes between the value of preceding VOP in seconds and the value of current VOP in seconds, and is coded with as many “1” as the changes. In other words, when time of second unit is the same as a preceding VOP, it is coded with “0”; when different by one second, it is coded with “10”; and when different by two seconds, it is coded with “110”. vop_time_increment information indicates information of less than second in each VOP with accuracy indicated by vop_time_increment_resolution.

vop_coded indicates whether it is followed by coded information about the frame. When the value of vop_coded is “0”, the frame has no coded data, and in a reconstructing side, a reconstructed image of a first preceding frame is displayed without modification.

intra_dc_vlc_thr contains information for identifying whether DC components of DCT coefficients in intra-frame coding macroblocks are coded with a different coding table from that for AC components or the same coding table as it. Which of the coding tables is to be used is determined in units of macroblocks from the value of intra_dc_vlc_thr and the quantization accuracy of DCT coefficients in each macroblock.

vop_quant is a value (initial value of quantization parameter) indicating quantization accuracy in quantizing DCT coefficients, and is the initial value of quantization accuracy of the frame vop_fcode_forward and vop_fcode_backward indicate a maximum range of motion amount in MC. A function sprite_trajectory( ) is information occurring when vop_coding_type is S-VOP, and functions to code motion vectors (global motion vectors) indicating the motion of a whole image (details are given later).

FIG. 20 shows a basic data structure (I-VOP, P-VOP, and S-VOP) 2200 of macroblock not_coded, which is a 1-bit flag used for P-VOP and S-VOP, indicates whether it is followed by data on the macroblock. When “0”, not_coded indicates that it is followed by data on the macroblock, and when “1”, not_coded indicates that following data is data on a next macroblock and a decoded signal of the macroblock is copied from a same position of a preceding frame (for S-VOP, a preceding frame subjected to deformation processing according to the motion of a whole image indicated by sprite_trajectory( )).

mcbpc is a variable length code of 1 to 9 bits mb_type indicating a coding type of the macroblock and cbpc (for blocks subjected to intra-frame coding, indicates whether AC components of quantization DCT coefficients exist) indicating whether quantization DCT coefficients (not zero) to be coded exist within two color difference blocks are expressed in a single code, respectively.

Coding types indicated by mb_type include intra, intra+q, inter, inter+q, inter4v (inter4v indicates that the unit of motion compensation for a luminance signal is not 2101 of FIG. 14 but four small blocks from 2101-1 to 2101-4), and stuffing intra and intra+q indicate intra-frame coding; inter, inter+q, and inter4v indicate predictive coding; and stuffing indicates dummy data for adjusting coding rate. “+q” indicates that quantization accuracy of DCT coefficients is changed from the value (quant) of a preceding block or an initial value (vop_quant, applied to a first coded macroblock of the frame).

For stuffing, mcsel and data following it within FIG. 20 are omitted, and the values of decoded mcbpc and not_coded are not reflected in the synthesis of a reconstructed image mcsel, which is information contained only when vop_coding_type is S-VOP and mb_type is inter or inter+q, gives selection information indicating whether motion compensation is performed with motion vectors (local motion vectors) of MB unit or global motion vectors. When the value of mcsel is “1”, motion compensation is performed with global motion vectors.

ac_pred_flag, which is information contained only when mb_type indicates intra-frame coding, indicates whether, for AC components of DCT coefficients, prediction is to be made from surrounding blocks. When the value of ac_pred_flag is “1”, part of quantization reconstructed values of AC components is prediction difference values from surrounding blocks.

cbpy is a variable length code of 1 to 6 bits and indicates whether coded quantization DCT coefficients (not zero) exist within four luminance blocks (like cbpc, for intra-frame coding blocks, indicates whether AC components of quantization DCT coefficients exist).

dquant, which exists only when mb_type is intra+q or inter+q, indicates an difference value from the value of quantization accuracy of a preceding block, and quant+dquant is quant of the macroblock.

Information on the coding of local motion vectors is contained in cases where mb_type indicates predictive coding, vop_coding_type is S-VOP, and mcsel is “0”, and in cases where vop_coding_type is P-VOP.

Intra difference DC components are information contained only when mb_type indicates intra-frame coding and use_intra_dc_vlc is “1”. With MPEG-4 video, DC components of DCT coefficients in intra-frame coding blocks are quantized as to difference values from DC components of DCT coefficients in surrounding macroblocks. Quantization methods for DC component are different from those for AC components, and different coding method from those for AC components are provided.

However, by setting use_intra_dc_vlc to “0”, quantized values of DC components can be subjected to the same coding method as for quantized values of AC components. The value of use_intra_dc_vlc is determined from intra_dc_vlc_thr defined in the VOP header and quant of the relevant macro block.

Only blocks in which “nonzero quantization coefficients exist, indicated by cbpy and cbpc”, have information about intra AC component or inter DC & AC component.

### SUMMARY OF THE INVENTION

The present invention covers cases where moving images to be coded according to the MPEG specification are monitoring video from monitoring camera. Although described in detail later, some monitoring video comes from a surveillance system (first surveillance system) having a preset function and other monitoring video comes from a surveillance system (second surveillance system) having a switcher-based camera switching function.

In the first surveillance system having a preset function, monitoring video is obtained by repeating a process that one monitoring camera shoots video of a specified direction and position for a given time, then the monitoring camera is panned to face a different, specified direction and position, and shoots video of that direction for a given time. This specification refers to as preset the operation that a monitoring camera is directed to a specified direction and position, that is, a shooting place of surveillance target, to perform surveillance for a given time, and then the surveillance target is shifted to a next shooting place. By presets, required pan-tilt-zoom (referred as to PTZ in the following) motions are performed in a given order.

The second surveillance system having a switcher-based camera switching function has plural fixed monitoring cameras and obtains monitoring video by switching video from the plural monitoring cameras by a switcher.

In the first surveillance system, a whole shooting place changes greatly during PTZ motion. However, video at that time is not required for surveillance. Also in the second surveillance system, a whole shooting place changes greatly during switch changeover.

In the MPEG coding system using inter-frame differences to reduce a transmission band, a data amount required for image coding during PTZ motion or switch changeover increases with great change of shooting places, to squeeze the band. As a result, bands allocated to important portions decrease and the problem of reduction in image quality occurs.

For the duration of PTZ motion, in many cases, the camera is not focused for durability reasons, in which cases motion compensation become difficult. Insufficient motion compensation reduces compression effect and increases a data amount. As a result, coding cancellation may occur, highly reducing image quality.

An object of the present invention is to provide a coding apparatus, a decoding apparatus, and a coding method for monitoring video to obtain high quality images by curbing an increase in a data amount occurring during PTZ motion of camera or switching of plural cameras.

The above problem of the present invention can be effectively solved by providing frame memories for each storing an input image from a monitoring camera changing shooting places of surveillance target by PTZ motion for each of different shooting places, and at the start of PTZ motion of camera, switching an input image to be coded from an input image from the camera to a past input image in a shooting place after the end of the PTZ motion, stored in the frame memories.

The above problem of the present invention can, aside from the above method, be effectively solved by providing data memories for each storing coded data for each of shooting places of surveillance target, and at the start of PTZ motion of camera, switching coded data to be outputted from coded data of an input image from the camera to past coded data in a shooting place after the end of PTZ motion, stored in the data memories.

Since monitoring video naturally changes little in a same shooting place regardless of the elapse of time, an increase in a coded data amount can be curbed by using past images in coding after the end of PTZ motion. With this idea in mind, the present invention has been made. Use of video changing greatly during PTZ motion can be avoided by the present invention, thereby enabling effective use of transmission band and making it possible to produce high quality decoded images.

PTZ motion timing, time of PTZ motions in a given order by presets, and the timing and time of switch change over described later depend on surveillance systems. In the present invention, such timing and time are used.

By the way, even for video changing greatly during PTZ motion, if a data amount of motion vector information used in motion compensation can be reduced, video during PTZ motion can be used. In this case, if PTZ motion operation settings between shooting places of surveillance target are fixed, global motion between shooting places does not change with time. The present invention uses this nature.

Specifically, the above problems of the present invention can, aside from the above methods, be effectively solved by using global motion vectors indicating motion of the whole input image, a search area (its center is in a position indicated by a global motion vector) for searching local motion vectors, and the coding frame rate for the input image as parameters, and by setting prediction accuracies of a coding frame rate and motion vectors for an input image during PTZ motion through updating relevant parameters during PTZ motion every PTZ motion. This is because the parameters are converged by the updating and the prediction accuracies of a coding frame rate and motion vectors can be set so that coded data during. PTZ motion reduces.

Also in cases where plural monitoring cameras are switched for each of shooting places of surveillance target, the nature that monitoring video changes little in a same shooting place regardless of the elapse of time is used.

The above problems of the present invention can, aside from the above methods, be effectively solved by, in addition to frame memories for storing decoded images by local decoding, providing a reference image memory for storing a decoded image for each of shooting places of surveillance target as a reference image, and switching, during camera switching, a decoded image used to detect motion vectors from a decoded image of an input image to a past reference image in a shooting place after camera switching, stored in the reference image memory.

If such means are adopted, instead of creating, as a reference image, a reconstructed image for motion compensation using images changing greatly every switching, a past reference image already stored is used. As a result, a coded information amount is reduced, achieving efficient use of transmission band and high quality of coded images.

These and other objects and many of the attendant advantages of the invention will be readily appreciated as the same becomes better understood by reference to the following detailed description when considered in connection with the accompanying drawings.

### BRIEF DESCRIPTION OF THE DRAWINGS

FIG. 1 is a configuration diagram for illustrating a surveillance system having a preset function;

FIG. 2 is a configuration diagram of a surveillance system having a switcher-based camera switching function;

FIG. 3 is a configuration diagram for illustrating an embodiment of an encoding apparatus of the present invention;

FIG. 4 is a flowchart for illustrating an embodiment of a coding method of the present invention;

FIG. 5 is a configuration diagram for illustrating an embodiment of a decoding apparatus of the present invention;

FIG. 6 is a configuration diagram for illustrating another embodiment of the encoding apparatus of the present invention;

FIG. 7 is a diagram for illustrating an example of global motion compensation processing;

FIG. 8 is a flowchart for illustrating another embodiment of the coding method of the present invention;

FIG. 9 is a diagram for illustrating a method for setting a search area of local motion estimation in the present invention;

FIG. 10 is a configuration diagram for illustrating a further embodiment of the encoding apparatus of the present invention;

FIG. 11 is a diagram for illustrating a coded data structure of reference image switching and updating information in the present invention;

FIG. 12 is a configuration diagram for illustrating another embodiment of the decoding apparatus of the present invention;

FIG. 13 is a diagram for illustrating macroblock splitting in MPEG-4 video coding;

FIG. 14 is a diagram of a configuration of macroblock in MPEG-4 video coding;

FIG. 15 is a configuration diagram of a conventional encoding apparatus;

FIG. 16 is a diagram for illustrating an outline of motion compensation processing;

FIG. 17 is a configuration diagram of a conventional decoding apparatus;

FIG. 18 is a diagram of an overall configuration of video coded data;

FIG. 19 is a diagram of a data configuration of VOP header in video coded data; and

FIG. 20 is a diagram of a data configuration of MB data in video coded data.

### DETAILED DESCRIPTION OF THE PREFERRED EMBODIMENTS

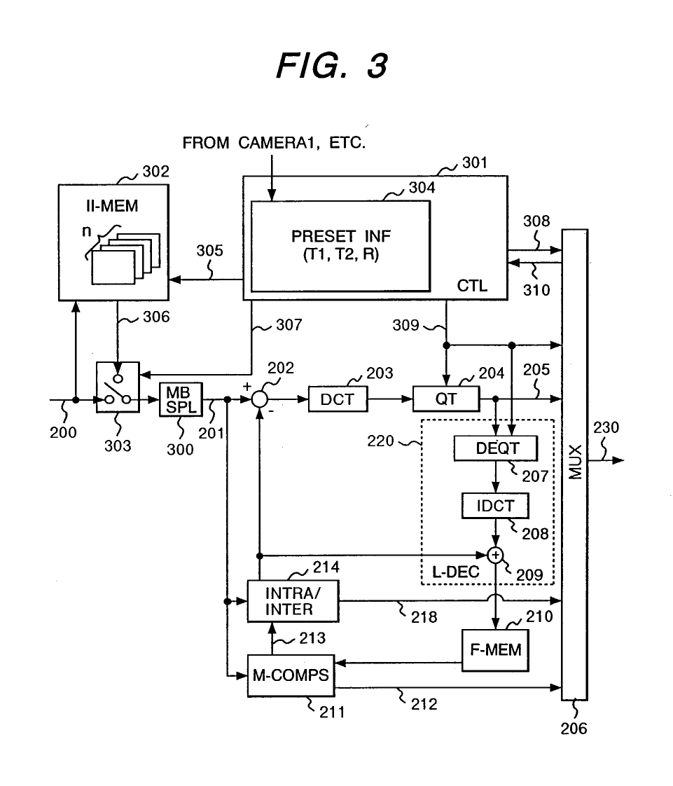

Hereinafter, an encoding apparatus, a decoding apparatus, a coding method, and a decoding method of the present invention will be described in more detail with reference to embodiments shown in the drawings. Identical reference numbers in FIGS. 3, 5, 6, 10, 12, 15, and 17 denote identical or similar components, and duplicate descriptions of them are omitted.

In many of power stations, transforming stations, plants, or rivers requiring a remote video surveillance system, it is difficult in terms of costs to newly build a dedicated wire network. For this reason, broadband networks (10 Mbps) and wireless LAN (Local Area Network) (11 Mbps) employing telephone DSL (Digital Subscriber Line) technology are being used as inexpensive alternative means. However, these networks tend to become about one order of magnitude narrower in band than normal LAN environments and efficient use of band is therefore important.

Efficient use of band requires the adoption of the MPEG coding system for compressing image data. However, in cases where data compressed by the MPEG coding system is distributed to a network in a surveillance system intended to monitor a wide range of area, an increase in information quantity caused by camera operations squeezes a transmission band, probably reducing video quality.

Accordingly, the present invention provides a method for achieving efficient use of transmission band and improvements in the quality of reconstructing compressed video, taking advantage of the characteristic that video in identical camera positions changes little regardless of the elapse of time.

A description will be made of an example of a remote video surveillance system to which an encoding apparatus and a decoding apparatus of the present invention are applied. Systems intended to monitor a wide range of area are broadly classified into the first and second surveillance systems described above.

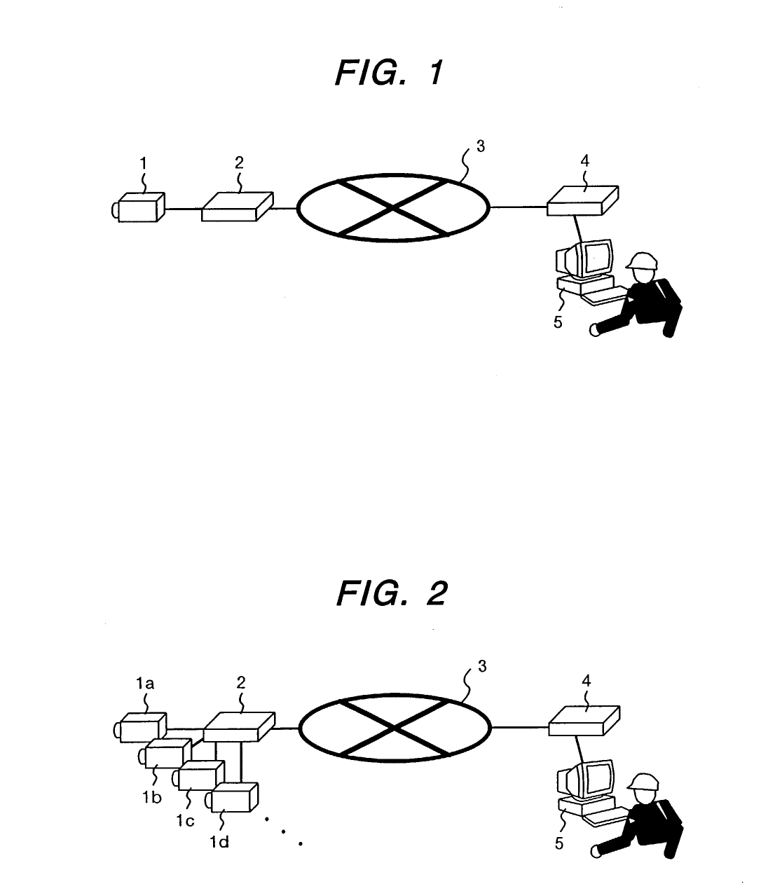

The first surveillance system is a low-cost system constituted by one camera and has a preset function. FIG. 1 shows an overall configuration of a preset-based network remote video surveillance system. With the preset, plural directions and places set in advance in a visual field are cyclically shot by PTZ motion of camera 1 and produced video is inputted to an encoding apparatus 2. In a surveillance side, data received over a network 3 is reconstructed by a decoding apparatus 4 and a supervisor 5 monitors an overall situation by one monitor. In this surveillance system, shooting places change rapidly during PTZ motion of camera. Therefore, if the same data coding means as when the camera is stationary is applied according to the MPEG coding system during PTZ motion of camera, a coded information amount (data amount) during that time may increase.

The second surveillance system, constituted of plural cameras, has a switcher function. FIG. 2 shows an overall configuration of a switcher-based network surveillance system. In this configuration, a supervisor 5 selects video in a desired position from videos shot by numerous cameras (1a, 1b, 1c, 1d, . . . ), and information about the selection is sent to an encoding apparatus 2 of a transmitting system over a network 3.

The encoding apparatus 2 of the transmitting system codes the selected video and distributes the coded video to the supervisor over the network 3 (the transmitting side may automatically make switching). In this surveillance system, shooting places differ between before and after switching. For this reason, in the MPEG coding system that, to code post-switching video, refers to pre-switching video to use correlation in time direction, a coded information amount may increase.

Referring to FIGS. 3 to 9, a description is made of an embodiment of the first surveillance system having a preset function, intended to curb an increase in such a coded information amount and provide high image quality.

A coding side is provided with as many frame memories for storing camera input images as a specified number of camera positions, that is, the number (n) of presets to introduce the system that, during PTZ motion, codes an image stored in a frame memory for a next camera position with high quality. The high-quality image is a past image in terms of time but has the nature that monitoring video changes little in a same shooting place regardless of the elapse of time, and therefore can be effectively used as a reference image during motion compensation.

In this case, since a past image not subject to surveillance is used during PTZ motion of camera, the end time of PTZ motion is predicted (may be correctly predicted) to set display time information indicating that PTZ motion is in progress. Time required for PTZ motion and the transmission rate of the network 3 are taken into account to decide a coded data amount of high-quality image to achieve the coding of high-quality image.

In a decoding side, the display time information and the like for a next frame are used to display on the monitor that a camera is in PTZ motion, and the time when image display is started is counted down, to tell the user that the system is not in trouble.

FIG. 3 shows the configuration of the encoding apparatus. An input image memory 302 is provided with as many frame memories as the number (n) of presets (set directions and places) The frame memories have a one-to-one correspondence with the preset positions. An input image 200 is stored in a corresponding frame memory as required. Although image storing to the frame memory may be always performed every camera input to continue updating the frame memory, not all input images may be stored. The input images may be regularly stored, for example, every several frames or every several hours.

A control unit 301 creates preset information 304 (during PTZ motion/stationary surveillance, transmission rate, and preset setting time) from information obtained from the camera 1 and network 3 (see FIG. 1), and performs switching of input images, image quality control, and the like. Upon obtaining information indicating that PTZ motion has been started, the control unit 301 passes post-PTZ motion camera position information 305 to the input image memory 302, and tells a switch 303 to output an image 306 of a frame memory corresponding to a post-PTZ motion camera position, using PTZ motion or surveillance information 307. Thereby, an input image 201 to the coding system is switched to a stored image.

When one image has been outputted from the frame memory, the control unit 301 tells the switch 303 to temporarily stop video output, using the PTZ motion or surveillance information 307. The stop of video output is cancelled when an indication that output is switched to the monitoring video 200 from the cameral is outputted to the switch 303 from the control unit 301 at the end of PTZ motion, using the PTZ motion or surveillance information 307.

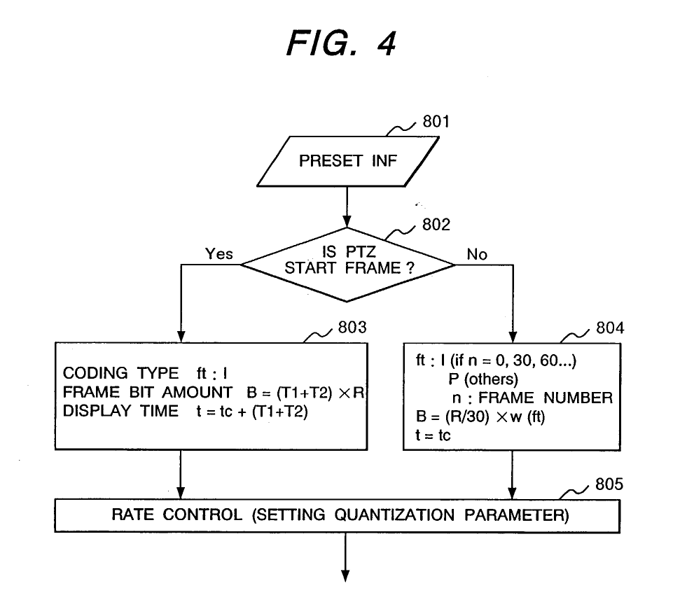

On the other hand, the control unit 301 controls quantization parameters so that an image in a post-PTZ motion camera position, coded during PTZ motion, becomes high quality. The process of the control is shown in FIG. 4. The control unit 301, in step 801, inputs preset information 304 (during PTZ motion/stationary surveillance, transmission rate, and preset setting time). In step 802, the control unit 301 determines from the preset information 304 whether an input image to be processed is a frame (PTZ motion start frame) in a post-PTZ motion camera position.

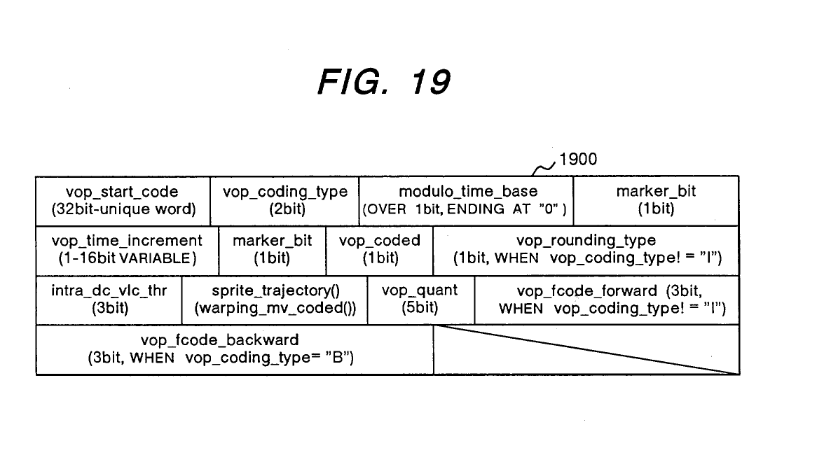

If it is a PTZ motion start frame, in step 803, the control unit 301 uses input data to set a coding type in I-VOP, a frame bit amount B in (T1+T2)×R, and display time t in t=tc+(T1+T2) T1 denotes a preset setting time; T2, a prediction value of time required for focusing after preset; R, transmission rate of the network 3; and tc, a current time. Frame information 308 consisting of the set display time and coding type is passed to a multiplexing unit 206 from the control unit 301 and synthesized in a VOP header 1900 shown in FIG. 19.

On the other hand, if it is not a PTZ motion start frame, as shown in step 804, a coding type, frame bit amount, and display time are set (n: frame number).

In step 805 for rate control processing, a quantization parameter used to code macroblock is set based on the frame bit amount B. Specifically, the control unit 301 finds a value that a total coding bit amount within a frame produced if all MBs within the frame are coded with an identical quantization parameter value would approximate to the frame bit amount B, and sets the value as an initial quantization parameter. Subsequently, from coding bit numbers of processed macroblocks, obtained from the multiplexing unit 206, the control unit 301 estimates the value of a quantization parameter with which unprocessed MBs are to be coded so as to approximate to the frame bit amount B, and modifies a quantization parameter obtained previously.

Although the above assumes that the preset information 304 (during PTZ motion/stationary surveillance, transmission rate, and preset setting time) is inputted from the outside, the same rate control and display time setting method can be applied also when the preset information 304 is set in the control unit 301 such as the case where it is programmed in advance.

Thus, coding is performed based on quantization parameters set so that an image in a post-PTZ motion camera position becomes high quality, and the coded data 230 is distributed to the network 3 from the multiplexing unit 206.

In this way, the coding and distribution method of the present invention for video during PTZ motion in preset makes a maximum use of time required for PTZ motion to code a post-PTZ motion image beforehand with high quality. Since the image can be used as a reference image during motion compensation after PTZ motion, the quality of subsequent image probably increases.

On the other hand, special processing is not necessarily required. However, since a high-quality image coded during PTZ motion is a past image in terms of time, it is different from an image to be displayed. Accordingly, to avoid misunderstanding, the image should be used only as a reference image during motion compensation and not displayed on a screen.

Since a monitor image is unchanged during PTZ motion, the user may have the doubt that the coding system is in trouble or the network is disconnected. To avoid this, information indicating that preset is in progress should be displayed on a monitor on a reconstruction side.

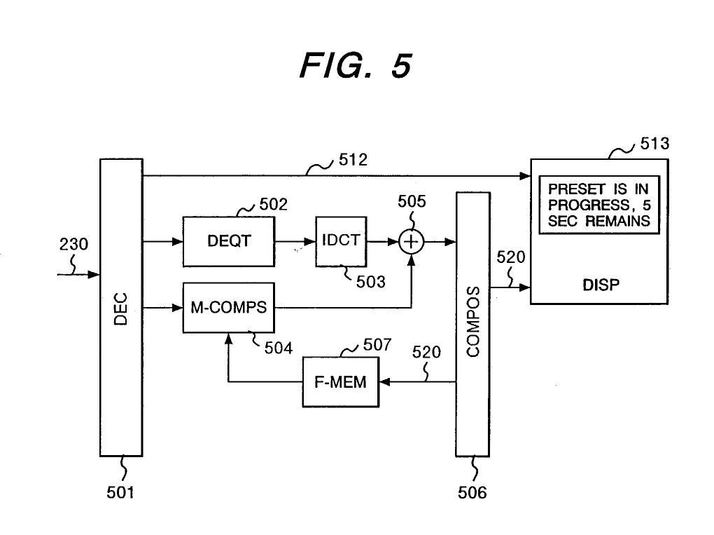

FIG. 5 shows a decoding apparatus that decodes the coded data 230 outputted from the encoding apparatus shown in FIG. 3. In FIG. 5, an example is shown that displays the above information on the screen of a display unit 513 to which a decoded frame image 520 is inputted from a compositor 506.

A time when a next display image is displayed can be determined from time information contained in the VOP header. Accordingly, immediately after decoding information of the VOP header, a decoding unit 501 passes time information 512 to the display unit 513.

If there is a given time before the next display time, the display unit 513 displays information indicating that preset is in progress, and at the same time displays a remaining time before the display is started. The display enables the user to recognize that the surveillance system is functioning. If the display unit 513 is devised not to display the first reconstructed image (decoded frame image) after preset end, a misunderstanding could be avoided that might occur if a past monitoring frame were displayed.

In FIG. 3, there are provided as many frame memories for input images as the number of camera directions and places. However, an increase in the image frame memories will increase costs of system apparatuses. Accordingly, one effective method is to provide, instead of the frame memories, memories for storing coded data after compression to store I-VOP coded data.

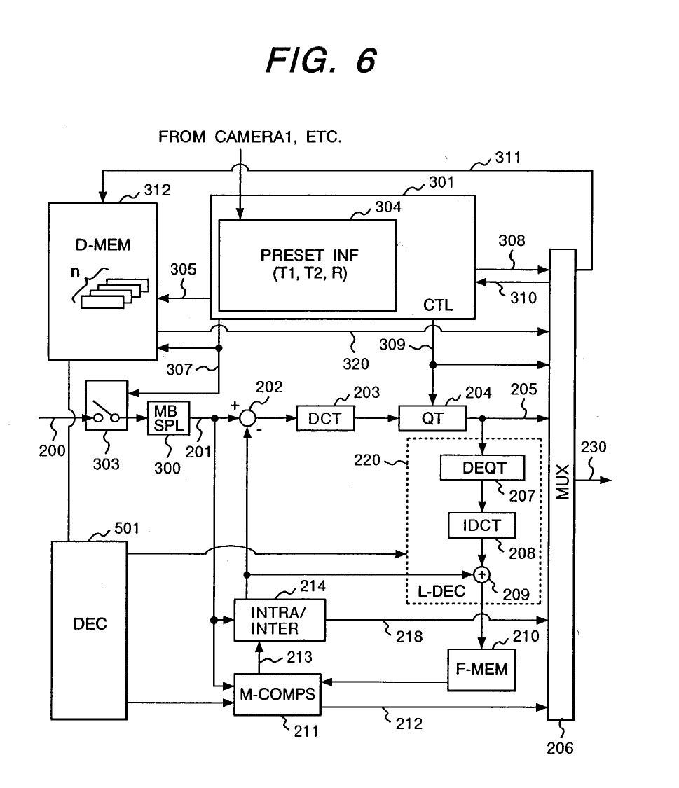

FIG. 6 shows an encoding apparatus designed to store coded data instead image frames. As in FIG. 3, an image data memory 312 is provided with as many data memories as the number (n) of presets (set directions and places). The data memories have a one-to-one correspondence with the preset positions. I-VOP coded data 311 created in the multiplexing unit 206 is stored in the data memories as required. As in FIG. 3, the data storing processing needs to be performed for not all I-VOPs.

At the start of preset processing, the control unit 301 sends post-PTZ motion camera position information 305 to the image data memory 312, reconstructs data corresponding to a post-PTZ motion camera position in the decoding unit 501, a local decoder 220, and a motion compensation unit 211, and stores the reconstructed image in a frame memory 210. At the same time, the control unit 301 uses the PTZ motion or surveillance information 307 to inform the switch 303 and image data memory 312 that data of a data memory corresponding to the post-PTZ motion camera position is outputted. It is effective to, in the meantime, subject a pre-PTZ motion input image into I-VOP coding in high resolution and update a corresponding data memory.

In response to the notification, the switch 303 temporarily stops video output. The stop of video output is canceled when information indicating the start of coding the monitoring video 200 is outputted from the control unit 301 to the switch 303 at the end of PTZ motion, using the PTZ motion or surveillance information 307.

On the other hand, the image data memory 312 sends coded data 320 corresponding to a camera position to the multiplexing unit 206. The control unit 301 uses the preset information 304 to set a display time t in t=tc+(T1+T2) Frame information 308 containing the display time information is passed to the multiplexing unit 206 from the control part 301 and synthesized in the VOP header 1900 (see FIG. 19) of the coded data obtained from the image data memory 312. The setting of time t may be omitted (the reconstructed frame may not be displayed), and the coded data 320 and the output data 230 from the multiplexing unit 206 may be switched for distribution to the network 3 by a switch provided additionally. The embedding of time t in the coded data 320 may be performed within the image data memory 312.

To obtain the same effect as in FIG. 3 from the above case, the coded data stored in the image data memory 312 is reconstructed to video of high quality by a method described below. For example, instead of stopping image output from the switch 303 at the start of PTZ motion, the switch 303 outputs one image 200 and the multiplexing unit 206 codes the image 200 by a rate control method at PTZ motion as shown in FIG. 4. The coded data 311 is stored beforehand in the image data memory 312 corresponding to a pre-PTZ motion camera position. If this method is used, the coded data 311 stored in the image data memory 312, that is, the coded data 230 distributed from the multiplexing unit 206 is reconstructed as video of high quality in the decoding apparatus.

In network environments in which a transmission rate changes greatly with time, not all the coded data 230 corresponding to data stored in the image data memory 312 may be distributed for the duration of PTZ motion. Accordingly, as an effective method, coded data n (equal to or greater than 2) times the number of camera positions is stored beforehand in the image data memory 312 and the data is selected to match a transmission rate of the network 3 during distribution.

Several methods may be employed for the timing of updating the contents of plural frame memories in the input image 302 shown in FIG. 3 and the contents of plural data memories in the image data memory 312. For example, updating is performed according to changes in time and brightness, or the encoding apparatus is informed of updating timing by a supervisor.

The above description does not cover a coding method when a camera is stationary. When a cameral is stationary, although P-VOP and B-VOP may simply be used according to determined rules, an effective method for monitoring video is to use I-VOP received during PTZ motion as a reference image at all times and perform coding by B-VOP only for prediction in forward directions. This method is particularly effective when the reference I-VOP is high quality. It is suitable in terms of random access.

Hereinbefore, a description has been made of a method of making images during PTZ motion into post-PTZ motion frames. Aside from this, a method is described for obtaining an image during PTZ motion by motion prediction. This method can also reduce a coded information amount by cutting motion vector information. Since an entire screen changes in a same direction at one time particularly during PTZ motion, motion compensation accommodable to this change is adopted.

By the way, the MPEG-4 specification provides a tool for cutting motion vector information of macroblock unit by coding camera parameters related to an entire screen. A prediction method of PTZ system of the present invention is implemented using the tool. The tool will be described.

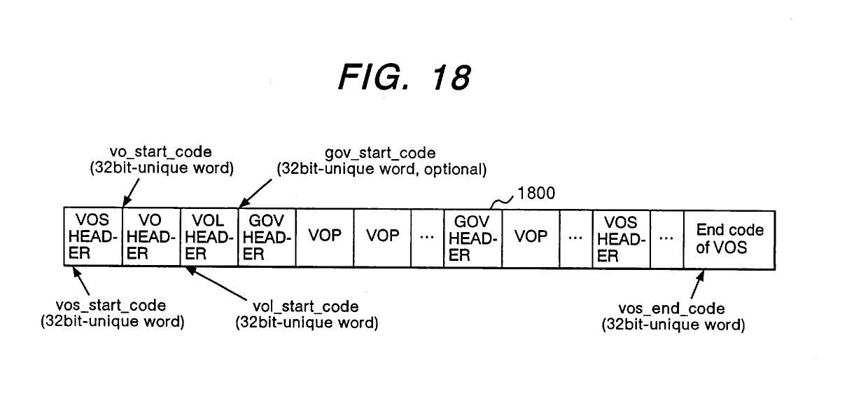

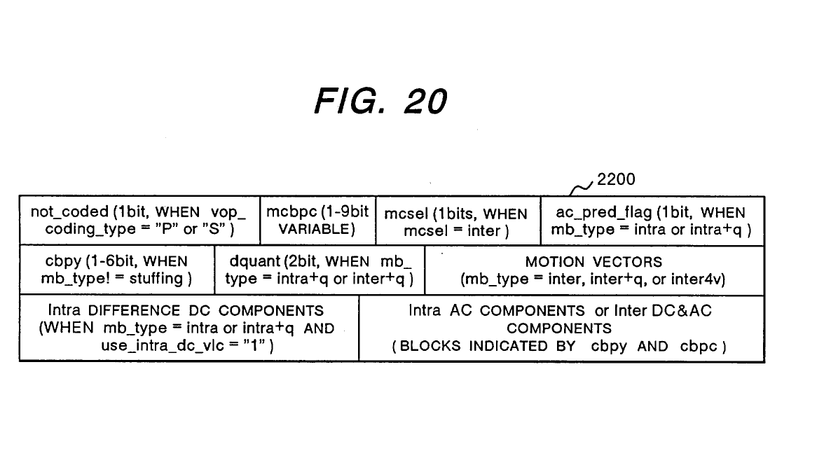

The tool, referred to as global motion compensation, is available for frames with vop_coding_type of “S-VOP” shown in FIG. 18, and is applied to macroblocks in which mt_type defined by mcbpc shown in FIG. 20 is inter or inter+q and mcsel is “1”. Global motion vector information for implementing global motion compensation is coded according to a function sprite_trajectory( ) shown in FIG. 19. Global motion compensation is described below. Motion compensation using global motion compensation is functionally part of a predictive coding system.

MPEG-4 provides four types of motion models: stationary, translational, isotropic transform, and affine transform. As sample motion vector accuracy, there are provided half sample accuracy, quarter sample accuracy, one-eighth sample accuracy, and one-sixteenth sample accuracy (local motion vector is half or quarter pixel accuracy). The identification information is coded in a VOL header.

An example of coding motion vectors in function sprite_trajectory( ) is shown using an example of affine transform. Affine transform is generally implemented by the following transform expression (1).

u_{g}(x,y)=a₀x+a₀y+a₂

v_{g}(x,y)=a₃x+a₄y+a₅ (1)

In the above expression, (u_{g}(x,y), v_{g}(x,y)) designates the motion vector of a pixel (x,y) within an image, and a₀ to a₅ designate motion parameters.

In MPEG-4 global motion compensation, as a method of coding motion parameters, a method of coding the motion vectors of image vertexes instead of a₀ to a₅ is adopted.

Now, it is assumed that a motion model is represented by affine transform of the expression (1), and coordinates of pixels at the upper left corner, upper right corner, lower left corner, and lower right corner of an image are represented by (0,0), (r,0), (0,s), and (r,s), respectively (r and s are positive integers).

Provided that the horizontal and vertical components of the motion vectors of warped points (0,0), (r,0), and (0,s) are (uₐ, vₐ), (u_{b},v_{b}), and (u_{c},v_{c}), respectively, the expression (1) can be replaced by an expression (2).

$$\begin{matrix}{u}_{g} = \frac{{u}_{b} - {u}_{a}}{r} x + \frac{{u}_{c} - {u}_{a}}{s} y + {u}_{a} \\ {v}_{g} = \frac{{v}_{b} - {v}_{a}}{r} x + \frac{{v}_{c} - {v}_{a}}{s} y + {v}_{a}\end{matrix} \qquad ( 2 )$$

This means that the same function can be realized even if uₐ, vₐ, u_{b}, v_{b}, u_{c}, and v_{c} are transmitted instead of a₀ to a₅.

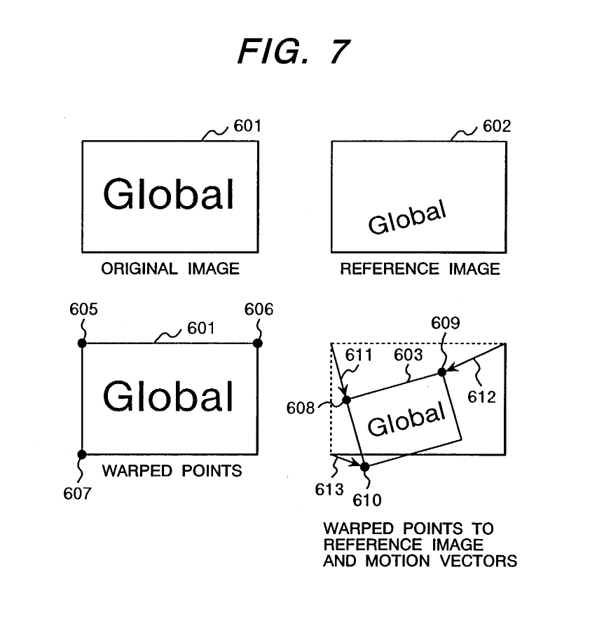

As an example of motion compensation, there is shown a method of compensating motion from a reference image 602 in FIG. 7 (preceding frame) to an original image 601 by the affine transform model. A coding side estimates motion parameters between the reference image 602 and the original image 601.

Next, from the motion parameters, the coding side finds global motion vectors 611, 612, and 613 at warped points 605, 606, and 607 at the upper left corner, upper right corner, and lower left corner of the original image 601. These global motion vectors show positions to which the warped points at the upper left corner, upper right corner, and lower left corner of the original image 601 correspond on the reference image. In this example, 603 is a motion compensation image, and 608, 609, and 610 are warped points to the reference image after motion compensation, and 611, 612 and 613 are motion vectors.

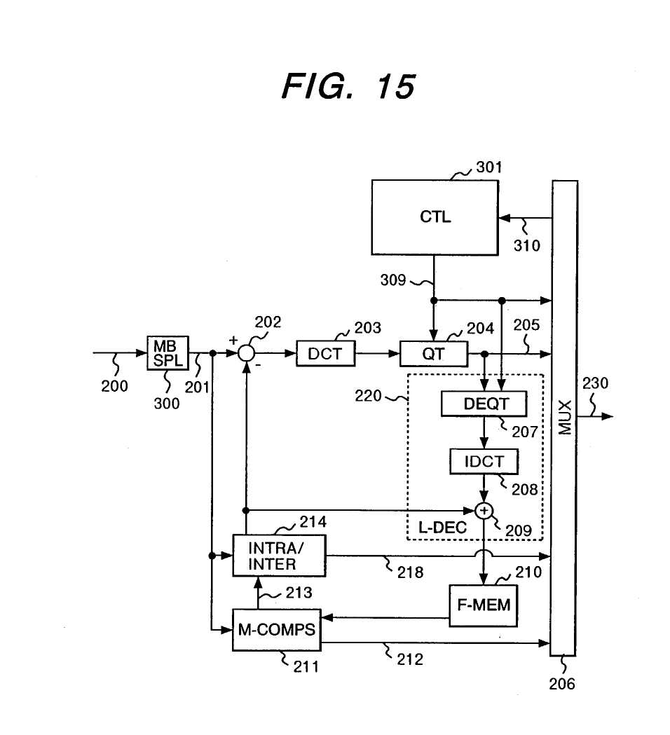

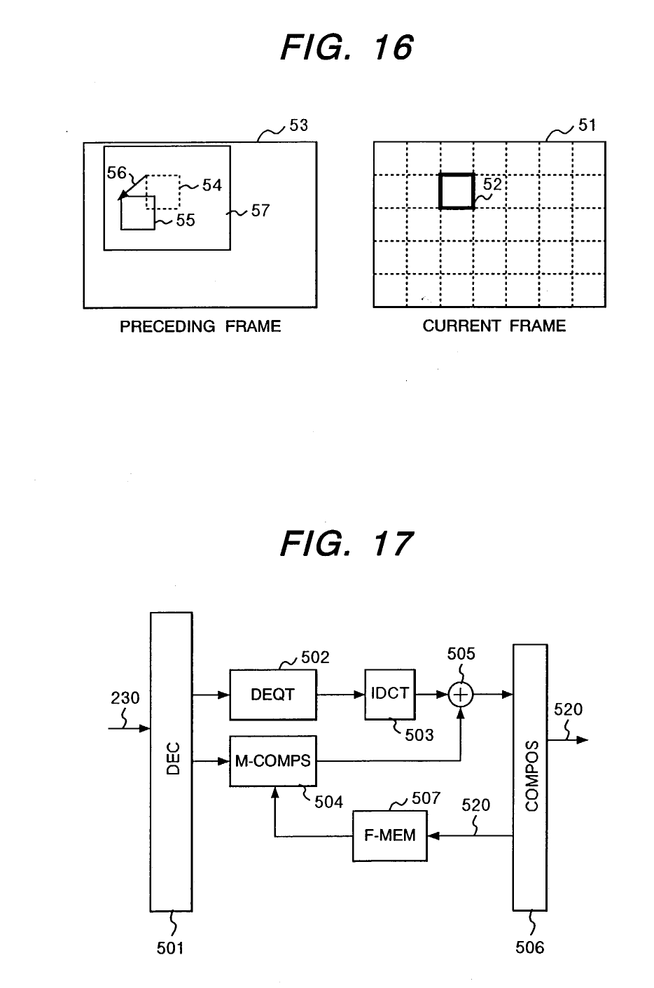

In a coding algorithm using global motion compensation, a function for predicting the global motion vectors is added to the motion compensation unit 211 of FIG. 15. Predicted global motion vectors 212 are sent to a multiplexing unit 206 together with local motion vectors 212 and coded.

The motion compensation unit 211 adds global motion compensation (the expression (2) is used to calculate local motion vectors of pixels within MB from global motion vectors) to options of prediction mode, and performs selection processing for each of MBs. Selection results of global motion compensation and local motion compensation are sent to the multiplexing unit 206 together with prediction mode information 218.

In MPEG-4 affine transform, a high-speed algorithm is applied, and the generalized expression (2), which is different from actual transform expressions, is used here for convenience of description.

On the other hand, in the decoding side, in the decoding unit 501 of FIG. 17, the global motion vectors are sent to the motion compensation unit 504 after being decoded according to sprite_trajectory( ) function. The motion compensation unit 504 is added with a function for calculating local motion-vectors of pixels within an image from global motion vectors as shown in the expression (2). Accordingly, the motion compensation unit 504, for MB specified to be subjected to global motion compensation in prediction mode, can synthesize a predicted MB image from global motion vectors of the frame.

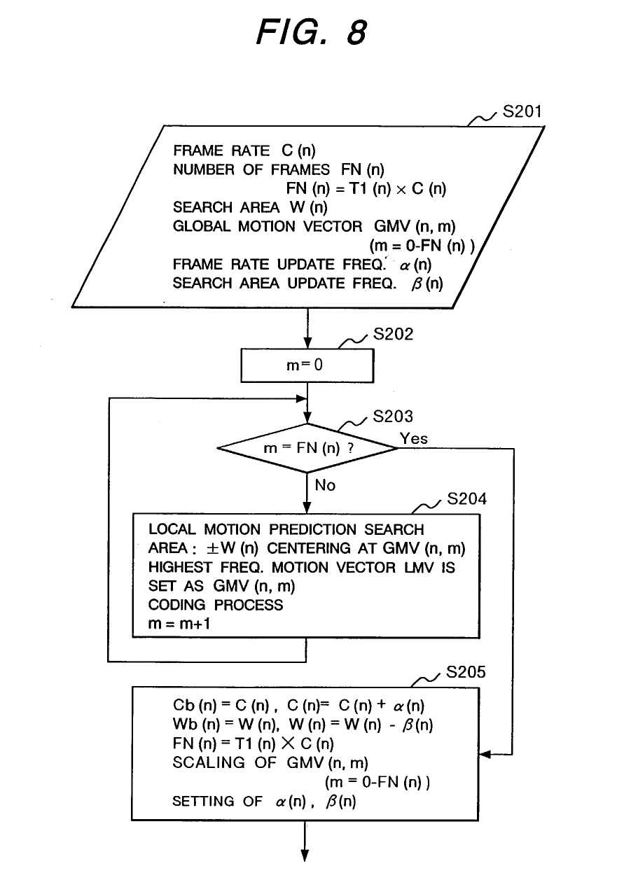

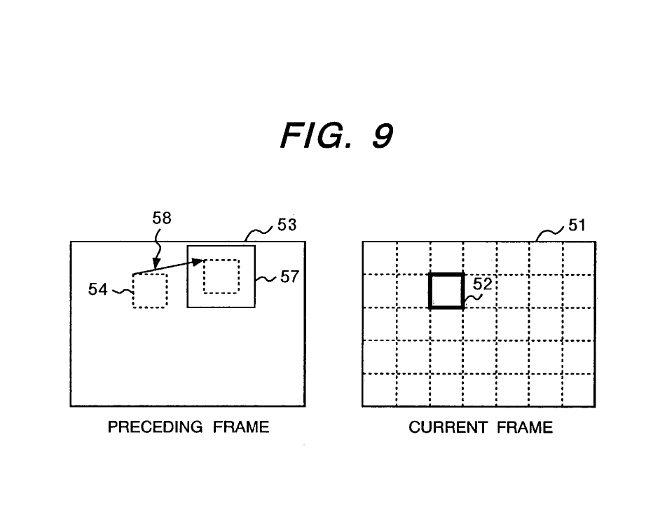

The prediction method of PTZ system of the present invention is implemented using the above described global motion compensation. The prediction method of PTZ system of the present invention is described using FIGS. 8 and 9.

This method uses the nature that, if PTZ motion settings between camera positions are fixed, global motion between camera positions is unchanged even if time elapses. Specifically, global motion vectors between frames to be coded are statistically predicted from local motion vector information of each frames, and the values of the vectors are updated every routing of camera operation. At the same time, using the predicted global motion vectors, every routing of camera operation, the updating is performed so that a search area of local motion prediction becomes narrower and a coding frame rate becomes larger.

FIG. 8 shows a coding process during PTZ motion. A coding system including S-VOP global motion compensation (translational model) is described here. At the start of PTZ motion, control parameters at the end of previous routing in this PTZ motion period are checked (step S201). Herein, n denotes a preset (PTZ motion period) number; C(n), a frame rate in preset n; FN(n), the number of frames to be coded in preset n; T1 (n), preset setting time in preset n (time required for PTZ motion); W(n), a search area of local motion prediction in preset n; GMV(n,m), global motion vector of frame m in preset n; α(n), frame rate update frequency in preset n; and β(n), search area update frequency in preset n.

In step S202, m=0 is set, and in step S203, it is judged whether m=FN(n) is satisfied. If not satisfied, control proceeds to step S204. If satisfied, control proceeds to step S205.

Although a frame rate during PTZ motion depends on a search area of motion compensation, since cases entailing camera operation involve global motion, a search area of local motion vectors cannot be set to be narrow. For this reason, at the time of surveillance when global motion vectors of vertexes are (0,0), a search area should be set to about 32 pixels. In this case, an initial frame rate may be 5 fps (frame per second).

In step S204, using the control parameters, frames (0) to (FN(n)) in the PTZ motion period are coded. At this time, a global motion vector is set to GMV(n,m) and prediction processing is not performed. On the other hand, local motion prediction is performed in a search area of ±W(n), centering at GMV(n,m).

FIG. 9 shows a method of setting a search area. In FIG. 9, for a luminance signal block 52 of a current frame 51, enclosed in a bold frame, a search area 57 is shown on a preceding frame 53. In this way, a search area is set in a position that is a translational component 58 of the global motion vector distant from a block 54 on the preceding frame in a spatially same position as the bold block of the current frame.

For local motion vectors (global motion vector GMV(n,m) is set for MB in which global motion vectors are selected) obtained as a result of the local motion prediction, their occurrence frequencies are statistically found. A motion vector having the highest frequency is defined as GMV(n,m) of a next routine.

After all frames within the PTZ motion period have been coded, the control parameters are updated in step S205 (Cb(n)=C(n), C(n)=C(n)+α(n), Wb(n)=W(n), W(n)=W(n)+β(n), FN(n)=T1(n)×C(n), scaling of GMV(n,m), (m=0−FN(n)), setting of α(n), β(n)). The update frequencies α(n) and β(n) basically have positive numbers. Therefore, the coding frame rate increases gradually and the search area reduces gradually. However, α(n) is set to 0 when the frame rate becomes 30 frames per second. β(n) may become negative only when reduction in a search area exerts influence on prediction performance and a coding bit amount increases. β(n) is converged to 0 while observing changes in coding bit amounts in each routine. The scaling of GMV(n,m) refers to modifying global motion vectors of each frame as a coding frame rate is updated. For example, for each frame after updating, global motion vectors are calculated from a relationship between global motion vectors of a frame closest in time and frame rates before and after updating.

Although the motion model of global motion vectors is translational in this example, the same processing can also apply to affine transform and the like by using translational components. However, without omitting prediction processing for global motion vectors, the global motion vectors must be calculated based on calculated prediction values of translational components. Although the algorithm including global motion compensation is used as an example here, the same converging means can also apply to algorithms including only local motion compensation. In this case, global motion vectors are used only to set a search area of local motion prediction.

In this way, it has become possible to predict the motion of images during PTZ motion by global motion vectors having a small amount of information. Use of such global motion compensation makes it possible to reduce a coded information amount of images during PTZ motion and following monitoring images.

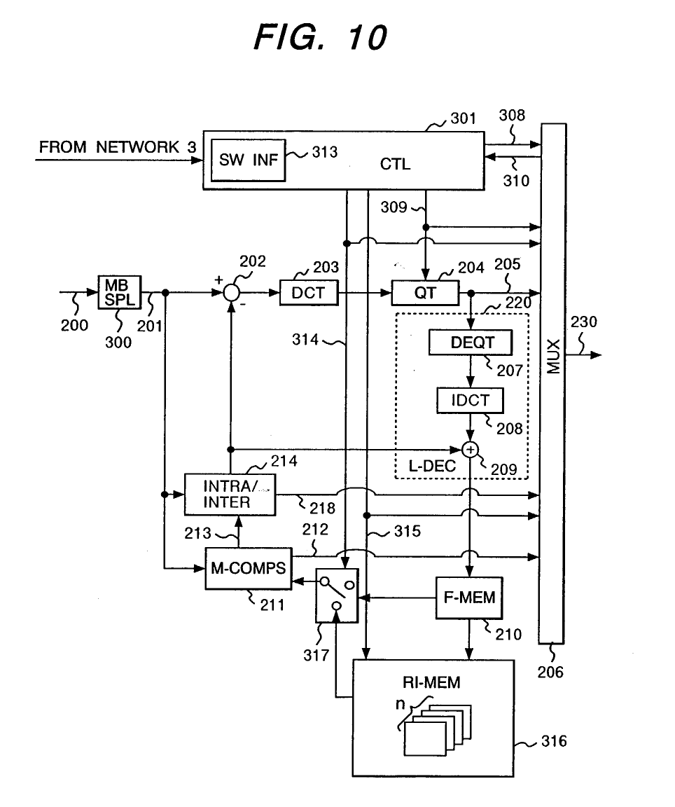

Next, referring to FIGS. 10 to 12, a description is made of an embodiment of a second surveillance system having a switcher-based camera switching function, designed to obtain high quality images without increasing a coded information amount.

In this embodiment, in a coding side and a decoding side, there are provided as many frame memories for storing reconstructed images (local decoded images) as the number of set camera positions. When input video is switched by the switcher, an image stored in a frame memory corresponding to a selected camera position is used as a reference image of motion compensation. At the same time, switching information of the reference image is passed to the decoding side. The image stored in the frame memory can be referred to as a camera switching reference image.

Thereby, a coded information amount during video switching or scene change which will inevitably increase with the MPEG coding system can be significantly reduced in comparison with cases where the present invention is not applied.

By selecting a high-quality image as the image (camera switching reference image) stored as the reference image, the image can also be used for intra-refresh for resetting DCT storage errors. Thereby, the coded information amount can be further reduced.

Coding session and decoding session that are different for different cameras may be provided, and the sessions may be switched at camera switching. Specifically, at camera switching, coding begins from a continuation of a bit stream in a camera position after switching and a local decoded image of video finally coded is used as a reference image. In this way, different streams are provided for different cameras. If this method is used, in the decoding side, data for individual cameras are stored for each of the cameras, and by combining the data, individual data can be treated as standard MPEG-4 data.

FIG. 10 shows a configuration of an encoding apparatus. Although the basic configuration is the same as that of the encoding apparatus shown in FIG. 3, in addition to the frame memory 210 for storing reconstructed images from the local decoder 220, a reference image memory 316 is provided. The reference image memory 316 is provided with as many frame memories as the number (n) of set camera positions. The frame memories have a one-to-one correspondence with the cameras. A reconstructed image stored in the frame memory 210 is further stored in a corresponding frame memory within the reference image memory 316 as required.

Although the reconstructed image storing process needs to be performed for not all reconstructed images, to match reference images during motion compensation between the coding side and the decoding side, update information is passed to the decoding side.

On the other hand, reference images during motion compensation are switched and updated based on information from the control unit 301. First, a method of switching reference images is described. The control unit 301 creates switch information 313 from information obtained from the network 3 (see FIG. 2), and passes information 315 of a current camera position to the reference image memory 316 and reference image switching information 314 to a switch 317 (these information items are passed to the multiplexing unit 206 at the same time) Thereby, a reference image during motion compensation of the frame is switched to an image (camera switching reference image) in a frame memory corresponding to the camera position information 315 within the reference image memory 316 by the switch 317.

As described above, the reference image switching is effective not only during scene change caused by camera switching but also during refresh for resetting storage errors caused by DCT. Also in this case, when the control unit 301 judges intra-refresh as necessary, information 315 of a current camera position is passed to the reference image memory 316, reference image switching information 314 is passed to the switch 317, and the same reference image switching is performed.

To obtain the effect of intra-refresh, a reconstructed image stored in the reference image memory 316 is preferably free from influence of DCT errors and highly quality. The following method is also effective for surveillance applications. Frame video used for other than the purpose of updating frame memories corresponding to camera positions is coded as B-VOP limited to prediction in forward directions, and random access can be available.

Next, a description is made of a method of updating reference images (camera switching reference images) stored in the frame memories within the reference image memory 316. When the control unit 301 judges an image stored in the reference image memory 316 to be updated, the control unit 301 passes camera position information and reference image storage order 315 to the reference image memory 316 (these information items are passed to the multiplexing unit 206 at the same time).

The reference image memory 316 copies an image within the frame memory 210 to a frame memory specified by the camera position information 315. As a timing when the image within the reference image memory 316 is updated, the timing when I-VOP having high quantization accuracy of DCT coefficients appears is selected. By thus keeping an image within the reference image memory 316 in high quality, the effect of reducing a coded information amount increases.

The reference image switching information 314, and camera position information and reference image storage command 315, shown in FIG. 10, are passed to the decoding side. These information are passed by synthesizing them in coded data of video, synthesizing them in a communication packet, or controlling them with activating a same program in the coding side and the decoding side.

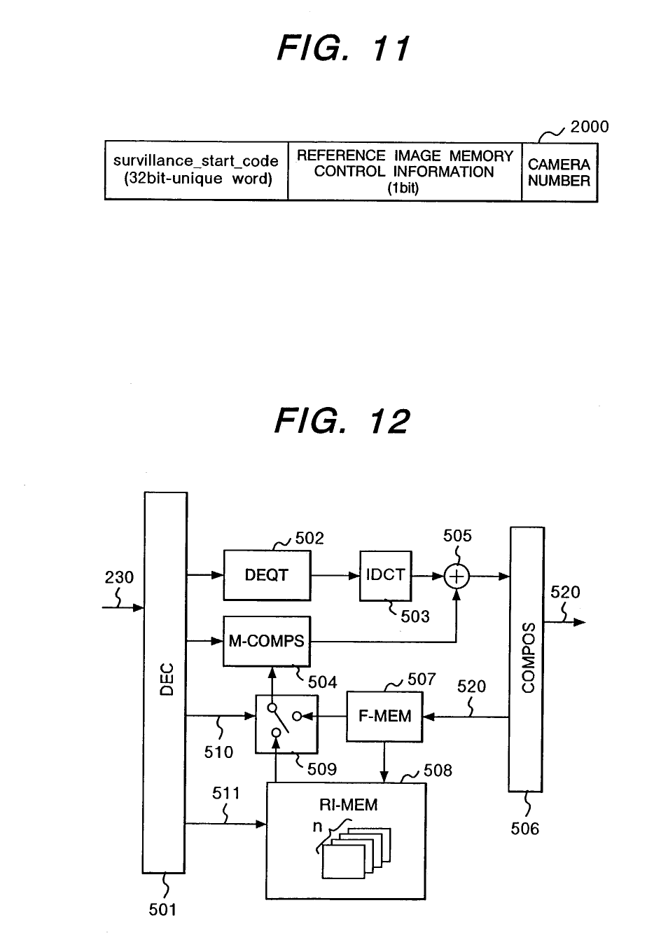

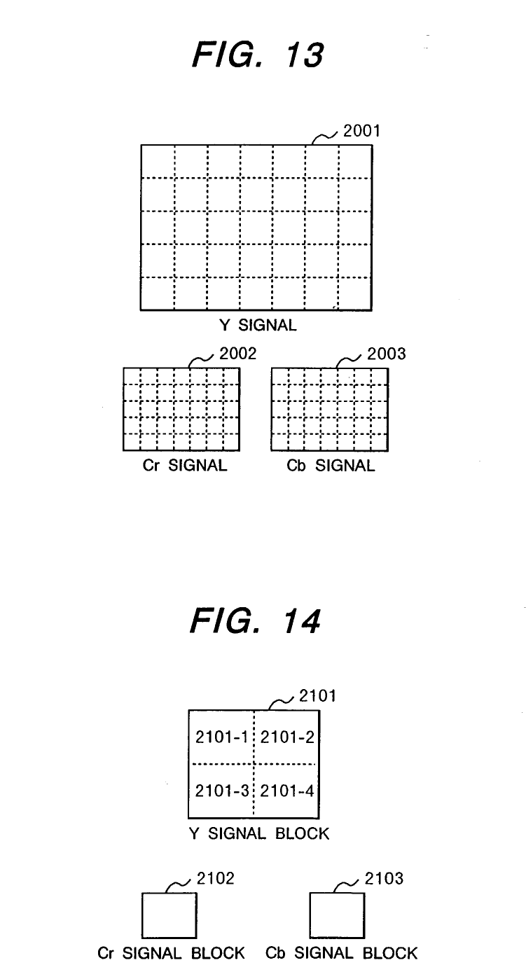

The method of synthesizing the above information in video data is shown in FIG. 11. Data 2000 shown in FIG. 11 is added between VOP data subjected to reference image switching or reference image updating surveillance-start_code is a 32-bit unique word and a searchable identification code like vop_start_code. Reference image memory control information indicates whether the type of preparatory processing for decoding of next VOP data is reference image switching or reference image updating. A following camera number indicates a camera position subject to processing.

The data of FIG. 11, created in the multiplexing unit 206, is inserted before the coded data of VOP involving reference image switching or behind coded data on VOP to update a reference image.

On the other hand, the decoding side makes data in the frame memory the same as that in the coding side, according to information shown in FIG. 11, passed from the coding side. FIG. 12 shows a configuration of the decoding apparatus. Like FIG. 10 of the encoding apparatus, in addition to a frame memory 507 for storing a reconstructed image, a reference image memory 508 is provided with as many frame memories as the number of set camera positions. The frame memories have a one-to-one correspondence with the cameras.

When information 510 indicating reference image switching and camera number information 511 have been decoded in the decoding unit 501, a reference image during motion compensation is switched to an image (camera switching reference image) in a frame memory within a reference image memory 508 by a switch 509. The reference image memory 508 outputs an image in a frame memory corresponding to the camera number information 511. When information indicating the updating of a reference image (camera switching reference image) in the reference memory 508 and a camera number 511 have been decoded in the decoding unit 501, an image in a frame memory 507 is copied to a frame memory within the reference image memory, corresponding to the camera number.

As a method of synthesizing the reference image switching information 314, and camera position information and reference image storage command 315 in a communication packet, which is another method for passing them to the decoding side, plural communication sessions are provided so that they are assigned to coded data for individual cameras. In this case, by bringing coded data of individual cameras into line with the MPEG-4 standards, individual receive data can be treated as MPEG-4 standard data in the decoding side.

Specifically, during camera switching, coding begins from a continuation of a bit stream in a camera position after switching and a local decoded image of video finally coded is used as a reference image. By using this method, in a receiving side, synthesis can bring a different MPEG-4 compliant stream for a different camera.

By thus using an image (camera switching reference image) stored in a frame memory corresponding to a camera position during camera switching by a switcher as a reference image of motion compensation, a coded information amount during camera switching can be reduced and high quality images can be obtained.

The present invention has been described using the MPEG coding system as an example. The characteristics of the present invention, “input image switching process during PTZ motion”, “motion prediction process during PTZ motion”, and “switching process of reference image for motion prediction during camera switching” can apply to any moving image coding systems involving prediction of time direction, and the same effect can be obtained.

In prediction of time direction, it is fundamental to code change portions (prediction error images) before and after a frame of moving image, and when a screen changes suddenly because of PTZ motion or camera switching, changes increase and a coded data amount increases. Since the above described processing of the present invention has the effect of curbing such sudden change of screen and increase of change portions, the present invention is effective without being limited to systems of coding change portions.

Therefore, although a coding system for input images and prediction error images in the MPEG system comprises DCT transform, quantization and variable length coding, the DCT transform by the DCT transformer 203 can be replaced by wavelet transform used in the JPEG system, which is the international standards of static image coding. Furthermore, without making transformation into frequency areas such as DCT transform and wavelet transform, error images, that is, prediction error images may be coded without modification.

With regard to a coding system implemented in the multiplexer 206, arithmetic coding used in the JPEG system can be used, instead of variable length coding using a coding table such as the MPEG system.

These cases can be implemented in the drawings in the embodiment by replacing and integrating components such as the DCT transformer 203, quantizer 204, multiplexer 206, inverse DCT transformer 208, dequantizer 207, and decoding unit 501.

Furthermore, also for motion compensation, input image switching during PTZ motion and switching of motion prediction reference image during camera switching of the present invention are effective for inter-frame prediction methods other than prior arts and shown in the embodiments. For example, the following prediction processing can be included in motion compensation and motion prediction of the present invention. That is, without searching motion vectors, motion vectors of all coded macroblocks are fixed to 0 vector, and a macroblock image in a spatially same position is picked out from a reference image.

Although not described in this embodiment, the present invention can also apply to coding systems that predict the values of input pixels from neighbor pixels in frame. In this configuration, a spatial prediction unit is provided in parallel to the motion compensation unit 211, and which of them was used is determined by an intra/inter switcher 214. The intra-frame prediction helps to increase the coding performance of the present invention but exerts no influence on the configuration of the present invention.

In overall conclusion, the present invention can apply to a coding system comprising a prediction unit and an encoder, wherein the prediction unit includes, for example, the local decoder 220, frame memory 210, motion compensation unit 211, and subtraction unit 202 that are shown in the embodiment, while the encoder, for example, includes the DCT transformer 203, quantizer 204, and multiplexing unit 206 shown in the embodiment. The prediction unit is defined as a unit creating a predictive image of a current input image from a decoded image of an image coded previously, and outputs a prediction error image between the input image and the predictive image. The encoder is defined as a unit encoding an error image or an input image to output coded data.

Additional characteristics of the present invention are described below.

(1) In a case where an encoding apparatus performing switching of input images during PTZ motion is provided with data memories, coded data, for each of shooting places of surveillance target, stored in the data memories, is coded data of an input image from a camera immediately before the PTZ motion.

(2) In a case where an encoder mounted in an encoding apparatus providing frame memories or data memories to perform switching process of input images during PTZ motion synthesizes time information indicating that a camera is in PTZ motion and indicating the time of PTZ motion in coded data to be outputted, the time information is created from external information indicating that the camera is in PTZ motion or in surveillance at a static state.

(3) In a case where a decoding apparatus for decoding coded data from an encoding apparatus providing frame memories or data memories to perform switching process of input images during PTZ motion outputs a display signal for displaying information indicating that a camera is in PTZ motion on a display unit, the display signal includes a signal for displaying the time of end of PTZ motion on the display unit.

(4) In a case where an encoding apparatus providing a reference image memory to perform switching process of motion prediction reference images during camera switching has a notification means for sending to a decoding side an identification number of a camera that corresponds to a camera switching reference image read from the reference image memory and a switching information indicating that switching to the camera switching reference image has been made, the notification means comprises a means for synthesizing the identification number and the switching information in coded data.

(5) In a case where an encoding apparatus providing a reference image memory to perform switching process of motion prediction reference images during camera switching has a notification means for sending to a decoding side an identification number of a camera that corresponds to a camera switching reference image read from the reference image memory and a switching information indicating that switching to the camera switching reference image has been made, and the notification means includes a means, when a camera switching reference image stored in the reference image memory has been updated, for sending to a decoding side the update information indicating that the camera switching reference image has been updated, the notification means comprises a means for synthesizing the identification number, the switching information and the update information in coded data.

(6) In a case where a decoding apparatus for decoding coded data from an encoding apparatus providing a reference image memory to perform switching process of motion prediction reference images during camera switching has a receiving means for receiving an identification number of a camera that corresponds to a camera switching reference image read from the reference image memory and a switching information indicating that switching to the camera switching reference image has been made, the receiving means comprises a means for separating the identification number and the switching information from the coded data and obtaining them.

(7) In a case where a decoding apparatus for decoding coded data from an encoding apparatus providing a reference image memory to perform switching process of motion prediction reference images during camera switching has a receiving means for receiving an identification number of a cameras that corresponds to a camera switching reference image read from the reference image memory and a switching information indicating that switching to the camera switching reference image has been made, the receiving means includes a means for receiving update information indicating that a camera switching reference image stored in a reference image memory has been updated, and the reference image memory updates a camera switching reference image according to the update information, the receiving means comprises a means for separating the identification number, the switching information and the update information from the coded data and obtaining them.

According to the present invention, since an increase in information amount of MPEG encoding occurring during PTZ motion of camera and during switching of plural cameras can be curbed by using past images, efficient use of a band for transmitting coded data is enabled and the quality of reconstructed images of monitoring video can be increased. For PTZ motion of camera, a coded data amount can be reduced by reducing an information amount of motion vectors, in addition to the method by the use of past images.

It is further understood by those skilled in the art that the foregoing description is a preferred embodiment of the disclosed device and that various changes and modifications may be made in the invention without departing from the spirit and scope thereof.

What is claimed is:

1. An encoding apparatus comprising:
a prediction unit that, for an input image coming from a monitoring camera changing shooting places by pan-tilt-zoom motion, creates a predictive image of the input image from a decoded image of an image coded previously, and outputs a prediction error image between the input image and the predictive image;
an encoder that codes the prediction error image or input image and outputs coded data; and
an image memory that stores an image for each of the shooting places,
wherein, at the start of pan-tilt-zoom motion of the monitoring camera, an image stored in the image memory is used.

2. The encoding apparatus according to claim 1, wherein:
the image memory have frame memories each of which stores the input image for each of the shooting places; and
the encoding apparatus further includes a switch for switching the input image to be coded from the input image coming from the monitoring camera to a past input image in a shooting place after the end of pan-tilt-zoom motion, the past input image being stored in a corresponding frame memory.

3. The encoding apparatus according to claim 1, wherein the image memory has data memories each of which stores the coded data, coded by the encoder, for each of the shooting places and at the start of pan-tilt-zoom motion of the monitoring camera, the coded data to be outputted is switched from the coded data of the input image coming from the monitoring camera to past coded data in a shooting place after the end of pan-tilt-zoom motion, the past data being stored in a corresponding data memory.

4. The encoding apparatus according to claim 2, wherein the encoder synthesizes information indicating that the monitoring camera is in PTZ motion and indicating the time of PTZ motion in coded data to be outputted.

5. The encoding apparatus according to claim 3, wherein the encoder synthesizes information indicating that the monitoring camera is in PTZ motion and indicating the time of PTZ motion in coded data to be outputted.

6. The encoding apparatus according to claim 2, wherein the encoding apparatus further includes the monitoring camera and processes an image shot by the monitoring camera as the input image.

7. The encoding apparatus according to claim 3, wherein the encoding apparatus further includes the monitoring camera and processes an image shot by the monitoring camera as the input image.

8. A decoding apparatus decoding coded data of an image obtained by a monitoring camera, wherein the coded data at the start of pan-tilt-zoom motion of the monitoring camera is switched to past coded data in a shooting place after the end of pan-tilt-zoom motion, the past coded data being stored in a data memory, and the decoding apparatus outputs a display signal for displaying information indicating that the monitoring camera is in pan-tilt-zoom motion on a display unit.

9. The decoding apparatus according to claim 8, wherein, by decoding information indicating that the monitoring camera, which is included in the coded data is in pan-tilt-zoom motion, the decoding apparatus outputs a display signal for displaying information indicating that the monitoring camera is in pan-tilt-zoom motion on the display unit.

10. A coding method comprising the steps of:
creating a predictive image of an input image from a decoded image of an image coded previously, the input image coming from a monitoring camera changing shooting places by pan-tilt-zoom motion;
outputting a prediction error image between a current input image and the predictive image; and
coding the prediction error image or the current input image and outputting coded data,
wherein the step of creating the predictive image includes a step of detecting motion vectors given to the predictive image from the input image and a reference image subject to motion compensation;
wherein a coding frame rate and a prediction accuracy of motion vector for an input image during pan-tilt-zoom motion are set from a relationship between a coded data amount and a coding operation amount during pan-tilt-zoom motion,
wherein the coding frame rate and the prediction accuracy of motion vector are obtained by updating parameters during every pan-tilt-zoom motion, the parameters comprising a global motion vector indicating motion of the whole input image, a search area for searching a local motion vector, and the coding frame rate for the input image, and
wherein the search area has a center thereof in a position indicated by the global motion vector.

11. The coding method according to claim 10, wherein the search area is updated so as to reduce the search area.

12. The coding method according to claim 10, wherein the coding frame rate is updated so as to approach to a frame rate of the input image.

13. The coding method according to claim 10, wherein the global motion vector is updated according to an occurrence frequency of the local motion vector within a frame after the local motion vector is detected, and in a way that modifies a global motion vector corresponding to a current frame rate so as to correspond to an updated frame rate at the termination of coding process in a pan-tilt-zoom motion period.

14. An encoding apparatus comprising:
a local decoder that, for an input image obtained by camera switching of a image coming from a monitoring camera provided for each of shooting places, creates a decoded image of an image coded previously;
a frame memory that stores output of the local decoder as a candidate for a reference image for motion compensation;
a predication unit that creates a predictive image of the input image by using the reference image outputted from the frame memory and outputs a prediction error image between the input image and the predictive image;
an encoder that codes the prediction error image or the input image and outputs coded data;
a reference image memory that stores a decoded image for each of shooting places, the decoded image being outputted from the local decoder, as a camera switching reference image;
a switch that, during camera switching, switches a reference image that the prediction unit uses for prediction of input image from the reference image read from the frame memory to a camera switching reference image in a shooting place after camera switching, the monitoring camera switching reference image being stored in the reference image memory; and
a notification means that sends to a decoding side an identification number of the monitoring camera corresponding to the monitoring camera switching reference image read from the reference image memory and a switching information indicating that switching to the monitoring camera switching reference image has been made.

15. The encoding apparatus according to claim 14, wherein the notification means includes a means that, when the monitoring camera switching reference image stored in the reference image memory has been updated, sends to the decoding side the update information indicating that the monitoring camera switching reference image has been updated.

16. A decoding apparatus decoding coded data, comprising:
a decoder that decodes the coded data and outputs a prediction error image;
a frame memory that stores past decoded image as a reference image for motion compensation;
a prediction unit that creates a predictive image using the reference image read from the frame memory and creates a decoded image from the predictive image and the prediction error image;
a receiving means that receives an identification number of a monitoring camera that corresponds to a camera switching reference image and a switching information indicating that switching to the monitoring camera switching reference image has been made, the identification number and the switching information being sent to the decoding apparatus;
a reference image memory that stores the decoded image for each of shooting places as the monitoring camera switching reference image of the corresponding camera, using the monitoring camera identification number; and
a switch that switches, according to the switching information, a reference image used to create the predictive image from the reference image read from the frame memory to the monitoring camera switching reference image in a shooting place after camera switching, stored in the reference image memory.

17. The decoding apparatus according to claim 16, wherein the receiving means includes a means for receiving update information indicating that the monitoring camera switching reference image stored in the reference image memory has been updated, and the reference image memory updates the camera switching reference image according to the update information.
